(19) United States
(12) Patent Application Publication
(10) Pub. No.: US 2003/0025792 A1
(43) Pub. Date: Feb. 6, 2003

(54) Canine remote video/audio system

(76) Inventor: Nicholas C. Eberhard, Middleport, NY (US)

Correspondence Address: Laurence S. Roach, JAECKLE FLEISCHMANN & MUGEL, LLP, Suite 200, 39 State Street, Rochester, NY, 14614-1310, US

(21) Appl. No.: 10/209,305

(22) Filed: Jul. 31, 2002

Related U.S. Application Data
(60) Provisional application No. 60/309,351, filed on Aug. 1, 2001.

(51) Int. Cl. H04N 7/18

(52) U.S. Cl. 348/143

(57) ABSTRACT

A canine remote audio/video system includes a custom molded skull cap formed from a mold of the head of a particular dog. The skull cap includes an opening for receiving each ear of the particular dog, a chin strap for securing the skull cap to the head of the dog, and a mount. A camera for recording visible light and/or infrared light, a microphone for recording sound in the vicinity of the dog, a speaker for broadcasting sound, and a light source emitting light compatible with the camera, are fixed to the mount. A power pack configured for being secured to the dog includes a power source providing electrical current, a transmitter for transmitting signals from the camera and the microphone to a remote receiver, and a receiver for receiving transmissions from a remote transmitter. At least one cable electrically interconnects the separate components.

### CROSS-REFERENCE TO RELATED APPLICATIONS

This application claims the benefit of U.S. Provisional Patent Application No. 60/309,351, filed Aug. 1, 2001.

### FIELD OF THE INVENTION

The present invention relates to remote audio and video equipment.

### BACKGROUND OF THE INVENTION

Police Officers in the conduct of their duties may encounter a variety of dangerous situations. For example, they may be required to give chase to armed and/or dangerous suspects, search buildings, woods or other hiding places in an effort to apprehend fleeing suspects, or conduct searches for explosive devices. In these efforts, Police Officers are sometimes assisted by dogs. The dog is typically assigned to and works with one Officer, and together they are referred to as a K-9 unit.

The dogs are specially trained to assist Officers in pursuing, locating and apprehending dangerous suspects, and to locate various types of contraband, such as drugs and explosive devices. Often, the dog is sent into a location where a suspect may be hiding or where contraband may be located which might otherwise be too dangerous for the officer to enter or be otherwise inaccessible to the Officer. In such circumstances, the dog serves as the eyes and ears of the officer. However, the officer has no way of knowing what the dog is seeing. Further, the capacity of the dog to communicate what he is seeing, or what he has found, is obviously limited. Due to these limitations, the duties and/or tasks of the dog are more limited than they otherwise might be.

Therefore, what is needed in the art is an apparatus and method that enables an Officer to see and hear what a police dog is seeing and hearing.

Furthermore, what is needed in the art is an apparatus and method that expands the functions or tasks for which a police dog can be used.

### SUMMARY OF THE INVENTION

A canine remote audio/video system includes a custom molded skull cap formed from a mold of the head of a particular dog. The skull cap includes an opening for receiving each ear of the particular dog, a chin strap for securing the skull cap to the head of the dog, and a mount. A camera for recording visible light and/or infrared light, a microphone for recording sound in the vicinity of the dog, a speaker for broadcasting sound, and a light source emitting light compatible with the camera, are fixed to the mount. A power pack configured for being secured to the dog includes a power source providing electrical current, a transmitter for transmitting signals from the camera and the microphone to a remote receiver, and a receiver for receiving transmissions from a remote transmitter. At least one cable electrically interconnects the camera and the microphone to the transmitter, the receiver to the speaker, and the power supply to the camera, microphone, speaker, light source, transmitter and receiver.

### BRIEF DESCRIPTION OF THE DRAWINGS

The above-mentioned and other features and advantages of this invention, and the manner of attaining them, will become appreciated and be more readily understood by reference to the following detailed description of one embodiment of the invention in conjunction with the accompanying drawings, wherein:

FIG. 1 is a perspective view of one embodiment of a K-9 remote video/audio system of the present invention;

FIG. 2 is a perspective view of one embodiment of the skull cap of FIG. 1 shown operably positioned on a police dog; and

FIG. 3 is a perspective view of the skull cap of FIG. 2.

Corresponding reference characters indicate corresponding parts throughout the several views. The exemplification set out herein illustrates one preferred embodiment of the invention, in one form, and such exemplification is not to be construed as limiting the scope of the invention in any manner.

### DESCRIPTION OF THE INVENTION

Referring now to the drawings, one embodiment of a K-9 remote audio/video system of the present invention is shown. K-9 remote audio/video system (hereinafter referred to as K-9 system) 10 includes skull cap 20 and power pack 30. Generally, K-9 system 10 is operably worn by a police dog, and transmits signals containing video and audio information from the area in which the dog is located to a remote receiver which is monitored by a Police Officer or other security personnel.

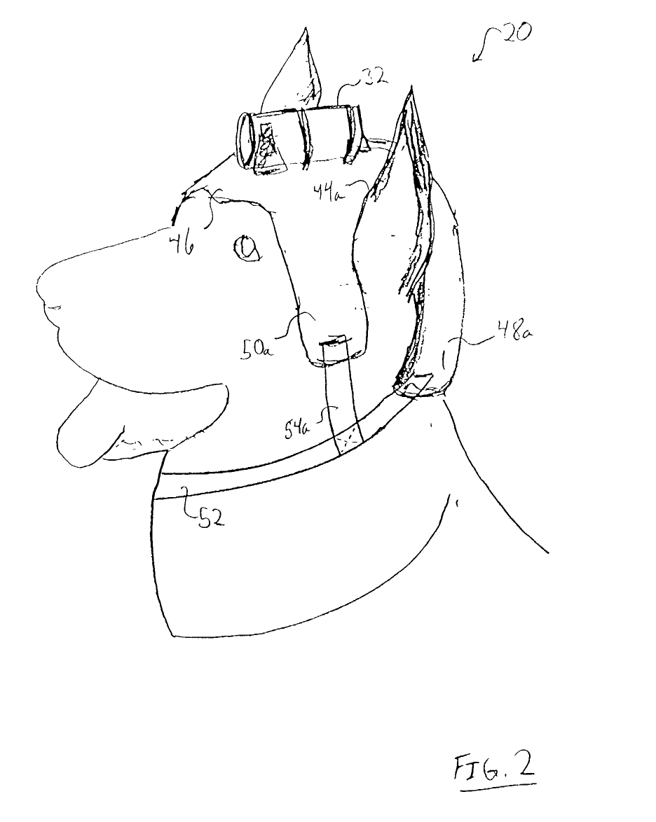

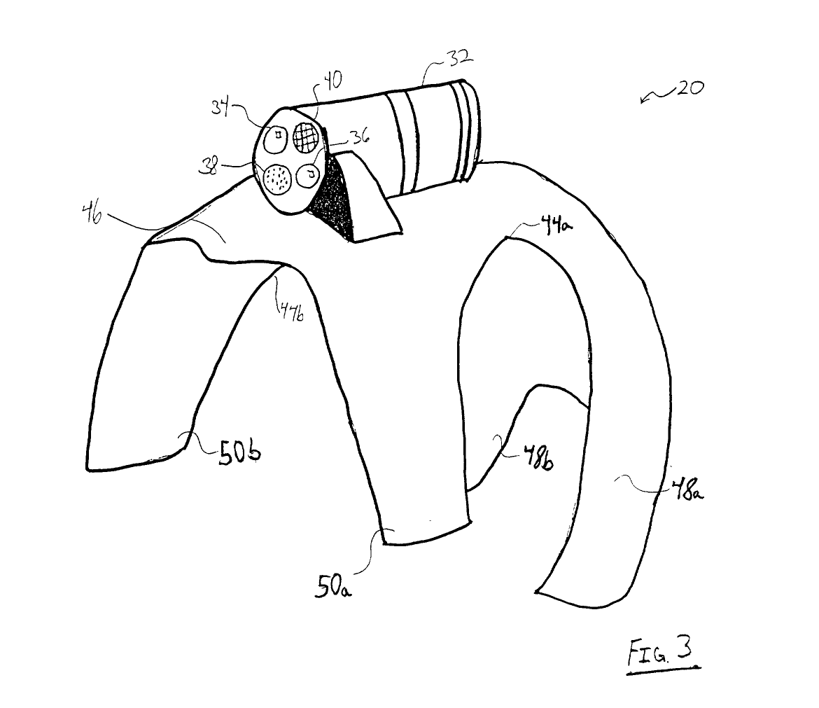

Skull cap 20, as best shown in FIG. 2, includes camera mounting tube 32. Camera mounting tube 32 is attached, such as, for example, by epoxy or other chemical bonding method, to skull cap 20. Alternatively, camera mounting tube 32 is formed integrally with skull cap 20. As best shown in FIG. 3, camera mounting tube 32 is configured to securely retain camera 34, light source 36, microphone 38, and speaker 40, which are connected to power pack 30 by cable 42.

Camera 34 is configured as, for example, an infra-red camera. Alternatively, camera 34 is configured as a visible light spectrum camera. Camera 34 captures images from the area in which the dog is located.

Light source 36 is configured to provide illumination of the area in which the dog is located that is compatible with camera 34. Thus, light source 36 is configured as an infra-red light source to appropriately illuminate the area in which the dog is located if camera 34 is configured as an infra-red light source. Alternatively, light source 34 is configured as a visible spectrum light source when camera 34 is correspondingly configured.

Microphone 38 captures audio sounds and information form the area in which the dog is located.

Speaker 40 transmits audio information, such as, for example, commands transmitted by a police officer, to the area in which the dog is located.

Cable 42 includes wiring that transmits power from power pack 30 to camera 34, light source 36, microphone 38, and speaker 40. Cable 42 further includes wiring to transmit a video and audio signal from camera 34 and microphone 38, respectively, to power pack 30 as well as to transmit an audio signal from power pack 30 to speaker 40.

Referring now to FIG. 2, skull cap 20 is molded to include openings 44a, 44b, which, in use, receive and are disposed around the dog's ears. Skull cap 20 further includes ridge portion 46 and rear tabs 48a, 48b. Ridge portion 46 closely engages the forehead of the dog, and rear tabs 48a, 48b closely engage the back of the head of the dog. Alternatively, rear tabs 48a, 48b closely engage the upper portion of the back of the neck of the dog. Forward tabs 50a, 50b closely engage a side of the head of the dog, between the eye and ear of the dog on either side of the head.

Chin strap 52 connects rear tabs 48a, 48b and is in two parts that are securely fastened together by a fastener such as, for example velcro straps or a clasp. Alternatively, chin strap 52 is a single strap of a length unique to a particular dog and is removably fastened to rear tabs 48a, 48b by fasteners such as, for example velcro tabs. Side straps 54a, 54b connect chin strap 52 to forward tabs 50a, 50b, respectively. When fastened, chin strap 52 closely engages the front of the neck of the dog to thereby securely hold skull cap 20 in place on the head of the dog. When chin strap 52 is unfastened skull cap 20 is easily removed from the dog.

Skull cap 20 is formed by first preparing a mold of a particular dog's head. Then, skull cap 20 is formed from the mold. In this way, skull cap 20 is custom fitted to each particular dog and the stability of skull cap 20 when operably disposed on the dog's skull is substantially improved. This added stability of skull cap 20 also improves image stability.

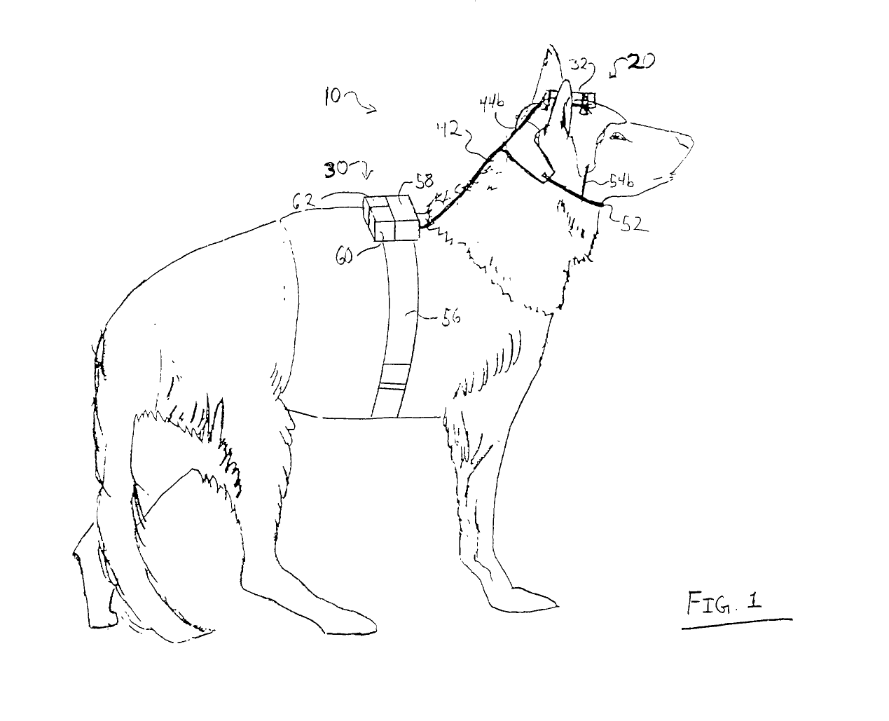

Referring now to FIG. 1, power pack 30 includes belt 56, power supply 58, transmitter 60, and receiver 62. Power pack 30 is attached, such as, for example, by epoxy or other chemical bonding method, to belt 56. Alternatively, power pack 30 slidingly engages belt 56 by, for example, belt loops.

Belt 56 is in two parts that are securely fastened together by a fastener such as, for example, velcro straps or a clasp. Belt 56 wraps around the dog, such as, for example, around the chest of the dog. Alternatively, power pack 30 is secured to an existing dog collar.

Power supply 58 includes a battery or other suitable source of electrical power, and is configured to supply electrical current to camera 34, light source 36, microphone 38, speaker 40, transmitter 60 and receiver 62.

Transmitter 60 is configured to receive video and audio signals from cable 42, and to convert the signals to signals, such as, for example, radio waves, which are suitable for transmission to and reception by a remote receiver (not shown), and to transmit those signals. Thus, the information captured by, for example, camera 34 and microphone 38 are transmitted to a remote receiver for observation.

Receiver 62 is configured to receive signals transmitted from a remote transmitter, which are, for example, broadcast over speaker 40 or used to control the operation of, for example, light source 36 and microphone 38.

In use, skull cap 20 and power pack 30 are securely strapped to the dog. As the dog navigates a potentially dangerous area, light source 36 illuminates the general area in which the dog is located. Light source 36 may be direction in nature, i.e., illuminating the area in front of the dog or in the general direction in which the head of the dog is facing (hereinafter referred to as the forward direction). Camera 34 records video from the area in the generally forward direction and sends the video signals through cable 42 to transmitter 60, which, in turn, transmits the video signals to a remote receiver (not shown). Similarly, microphone 38 captures audio information from the area surrounding the dog. The audio signals are provided through cable 42 to transmitter 60, which, in turn, transmits the audio signals to a remote receiver (not shown). The audio and video received by the remote receiver (not shown) is monitored by a human operator (not shown), such as, for example, police or other security personnel for observation.

The human operator (not shown) transmits information, such as, for example, voice commands, via electronic signals to the dog through the remote transmitter. The signals embodying the voice commands are received by receiver 62, which converts the signals to audio signals suitable for speaker 40. Speaker 40 broadcasts the voice commands such that they are audible to the dog, and to any suspects or other persons in the general vicinity of the dog.

It should be particularly noted that although camera mounting tube 32 is described for use with camera 34, light source 36, microphone 38, and speaker 40, any combination of these and other portable devices may be used.

It should even further particularly noted that the circuit containing light source 36 can be alternately configured to include a switch that is selectively switched between and on position and an off position from the remote transmitter (not shown). When the switch is in the on position, the circuit is complete and power is supplied to light source 36. When the switch is in the off position, the circuit is not complete and power is not supplied to light source 36. Thus, light source 36 is operably switched between an on and an off mode by the human operator (not shown).

While this invention has been described as having a preferred design, the present invention can be further modified within the spirit and scope of this disclosure. This application is therefore intended to cover any variations, uses, or adaptations of the present invention using the general principles disclosed herein. Further, this application is intended to cover such departures from the present disclosure as come within the known or customary practice in the art to which this invention pertains and which fall within the limits of the appended claims.

What is claimed:

1. A canine remote audio/video system comprising:
a custom molded skull cap formed from a mold of the head of a particular dog, including;
an opening for receiving each ear of the particular dog;
a chin strap for securing said skull cap to said head of said particular dog; and
a mount disposed on said skull cap;
a camera configured for recording at least one of visible light and infrared light, said camera securely fixed to said mount;
a microphone for recording sound in the vicinity of said particular dog, said microphone securely fixed to said mount;
a speaker for broadcasting sound securely fixed to said mount; and
a light source configured for emitting at least one of visible radiation and infrared radiation, said light source being securely fixed to said mount; and
a power pack configured for being secured to the dog, including:
a power source providing electrical current;
a transmitter for transmitting signals from said camera and said microphone to a remote receiver; and
a receiver for receiving transmissions from a remote transmitter;
at least one cable electrically interconnecting said camera and said microphone to said transmitter, electrically interconnecting said receiver to said speaker, and electrically interconnecting said power supply to said camera, said microphone, said speaker, said light source, said transmitter, and said receiver.

2. A method of providing a canine remote audio/video system, comprising the steps of:
making a mold of a head of a particular dog;
molding a skull cap from said mold with openings for receiving the ears of said particular dog;
attaching a video capture device to said skull cap;
affixing a sound capture device to said skull cap;
adding a sound projecting device to said skull cap;
appending a light projecting device compatible with said camera to said skull cap;
configuring a power pack for being carried by the dog, said power pack including a power supply providing electrical current to said video capture device, said sound capture device, said sound projecting device, and said light projecting device, said power pack further including a transmitter electrically connected to said power supply for transmitting to said power supply, and a receiver electrically connected to said power supply for receiving information from a remote transmitter;
electrically interconnecting said video capture device and said sound capture device to said transmitter, and said receiver to said sound projecting device.
